(19) United States
(12) Patent Application Publication
(10) Pub. No.: US 2008/0301759 A1
(43) Pub. Date: Dec. 4, 2008

(54) APPARATUS AND METHOD FOR APPLYING NETWORK POLICY AT VIRTUAL INTERFACES

(75) Inventors: James Paul Rivers, Saratoga, CA (US); Chaitanya Kodeboyina, San Jose, CA (US); Ravi Kumar Gadde, San Jose, CA (US)

Correspondence Address: SCHWEGMAN, LUNDBERG & WOESSNER, P.A., P.O. BOX 2938, MINNEAPOLIS, MN, 55402, US

(73) Assignee: Nuova Systems, Inc., San Jose, CA (US)

(21) Appl. No.: 11/927,317

(22) Filed: Oct. 29, 2007

Related U.S. Application Data
(60) Provisional application No. 60/941,510, filed on Jun. 1, 2007.

(51) Int. Cl. G06F 17/00; G06F 15/16

(52) U.S. Cl. 726/1; 709/236

(57) ABSTRACT

Methods and apparatus are disclosed for applying network policy to communications originating at operating system virtual interfaces. In an example embodiment, a network device is networked with a switch. The network device may include a first operating system interface, a virtualization adapter, and an input output port. In an example embodiment, the virtualization adapter receives a first frame from the first operating system interface. The virtualization adapter may tag the first frame to indicate an association between the first frame and the first operating system interface. The first frame may then be transmitted with a second frame being associated with a second operating system interface, to the switch via the input output port. In an example embodiment, the switch is configured to receive the frame, examine a tag and then to enforce a network policy upon the first frame, based on the tag.

### FIELD

The present disclosure relates generally to network communication. Example embodiments relate to enforcement of network policy upon communications from virtual interfaces.

### BACKGROUND

Network policy enforcement is commonly used to control network access by nodes on a network. For example, policy enforcement may be used to control a node's ability to access other nodes, to define a node's scope of privileges, to prevent denial of service attacks and to enforce firewall policies. An appropriate policy may be selected based on the identification or lack thereof of a node or a user.

### BRIEF DESCRIPTION OF THE DRAWINGS

Example embodiments of the are illustrated by way of example, and not by way of limitation, in the accompanying drawings and in which like reference numerals refer to similar elements and in which:

FIG. 1 illustrates a block diagram of an example embodiment of a network system;

FIG. 2 illustrates a block diagram of a further example embodiment of a network system;

FIG. 3 illustrates a block diagram of a yet further example embodiment of a network system;

FIG. 4 is a flow diagram of a method, in accordance with an example embodiment, for enabling the application of network policy enforcement;

FIG. 5 is a flow diagram of a further method, in accordance with an example embodiment, for enabling the application of network policy enforcement;

FIG. 6a illustrates example fields within a frame;

FIG. 6b-c illustrate block diagrams of network systems in accordance with example embodiments;

FIG. 7 illustrates a block diagram of a further network system, in accordance with an example embodiment;

FIGS. 8a, 8b and 8c are block diagrams illustrating example communication networks in which embodiments are applied; and

FIG. 9 shows a diagrammatic representation of a machine in the example form of a computer system within which a set of instructions for causing the machine to perform any one or more of the methodologies discussed herein, may be executed.

### DETAILED DESCRIPTION OF EXAMPLE EMBODIMENTS OVERVIEW

In some cases, an operating system located on a node accesses a network through a software operating system interface paired in a one-to-one fashion with a physical network interface. As such, one way to enforce network policy is to identify the node by the physical input/output (I/O) interface connecting it to the network. Here, one physical port corresponds to one operating system so the communications can be regulated.

In a virtual environment (e.g., a virtual server), a single physical device may appear to other hardware and software as multiple logical devices (e.g., multiple virtual devices). Thus, some network devices (e.g., physical devices) include one or more virtual interfaces, each of which connects one or more virtual machines to the network. A virtual machine may include an operating system that interfaces via multiple “virtual interfaces” to a network. Virtual interfaces allow applications, services and operating systems to separately access the network through the virtual interfaces using a common physical I/O interface to the network. When virtual interfaces are used, network policy may be enforced with hardware or software. The enforcement may occur within each network node or external to each node but within the network.

When network policy is enforced within a network node and network administrators update network policies, an implementation problem can arise leading to higher operational costs and a lack of administrative control. For example, if there were 5000 nodes on the network, each node would need to be capable of providing the desired level of enforcement and unfortunately each would need to be updated with software to effectively apply the new network policy to physical and virtual network interfaces.

When network policy is enforced external to a node but within the network, current practices only apply policy to physical network interfaces and not to the underlying virtual network interfaces. For example, affixing “tags” to Layer 2 frames allows the creation of a virtual local area network (multiple logical local area networks (LANs) within or across physical network nodes). A VLAN (Virtual Local Area Network) switch located on a network can only determine the physical port and cannot determine the virtual network interface from which a frame originated. Thus, a VLAN switch may not properly enforce network policy upon virtual network interfaces.

Example embodiments may be deployed in a network device (e.g., a server) and a switch that are communicate coupled with one another in a network system. The network device includes an operating system interface, a virtualization adapter, and an input output port. In various example embodiments, the virtualization adapter may receive a frame from the operating system interface and tag the frame to indicate that the frame is associated with the operating system interface. The frame may then be transmitted with another frame associated with a different operating system interface, via the input output port. In example embodiments, the switch may receive the frame and enforce a network policy upon the frame, based on the tag.

### Example Embodiments

In the following description, for purposes of explanation, numerous specific details are set forth in order to provide a thorough understanding of the present invention. It will be apparent, however, to one skilled in the art that the present invention can be practiced without these specific details.

In general, methods and apparatus are disclosed for applying network policy in the network itself to communications originating at operating system virtual interfaces. In an example embodiment, policy configurations relating to functionality at a network node (e.g., a network adaptor) may be set or configured in the network (e.g., at a single point in the network).

Example embodiments disclosed herein include receiving data from an operating system or multiple operating systems located on a network device (e.g. various operating systems located on a single computer's virtual machines). In an example embodiment, one or more operating system interfaces (e.g., a virtual interface) translates the data into frames on behalf of the operating system. The term frame is used by way of example herein and is intended to include a data packet of fixed or variable length which has been encoded by a data link layer communications protocol for digital transmission over a node-to-node link. Each frame may include a header and a frame synchronization, or optionally a bit synchronization, payload. Examples of frames include, but are not restricted to, Ethernet frames and Fibre Channel frames.

In an example embodiment, a virtualization adapter receives one or more frames from the operating system interface and tags the one or more frames with an indicator that indicates an association with its source operating system interface (e.g., a virtual interface). The one or more frames may then be configured to be transmitted over an I/O port (e.g., a physical input/output port) concurrently with other frames associated with various other operating system interfaces (e.g., interfaces to various operating systems instantiated in virtual machines), to a network switch.

Upon receipt of the one or more frames at the switch, the source of the one or more frames may be identified so that network policy may be applied at a point within the network and not, for example, at the destination node itself.

As explained by way of example above, the one or more frames is created by one or more operating system interfaces (e.g., virtual interfaces), that is interfaced with an operating system located on the network device. In an example embodiment, a policy enforcement module located within the switch may receive the one or more frames. The policy enforcement module may first identify a source I/O port associated with the one or more frames and then examine indicators (e.g., frame tags) located within the one or more frames (e.g., within a frame header) to identify the source operating system interface (e.g., a virtual interface) that generated the one or more frames. Based on an identified source I/O port and an identified source operating system interface, the policy enforcement module may enforce a network policy upon the at least one frame.

In the following detailed description of the embodiments, reference is made to the accompanying drawings that show, by way of illustration, specific example embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in an embodiment may be included within other example embodiments. The following detailed description is, therefore, not to be taken in a limiting sense, and the scope of the present invention is defined only by the appended claims, along with the full scope of equivalents to which such claims are entitled.

Some portions of the detailed descriptions that follow are presented in terms of algorithms and symbolic representations of operations on data bits within a computer system's registers or memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or the like, may refer to the actions and processes of a computer system, or similar electronic computing device, that manipulates and transforms data represented as physical (electronic) quantities within the computer system's registers and memories into other data similarly represented as physical quantities within the computer-system memories or registers or other such information storage, transmission or display devices.

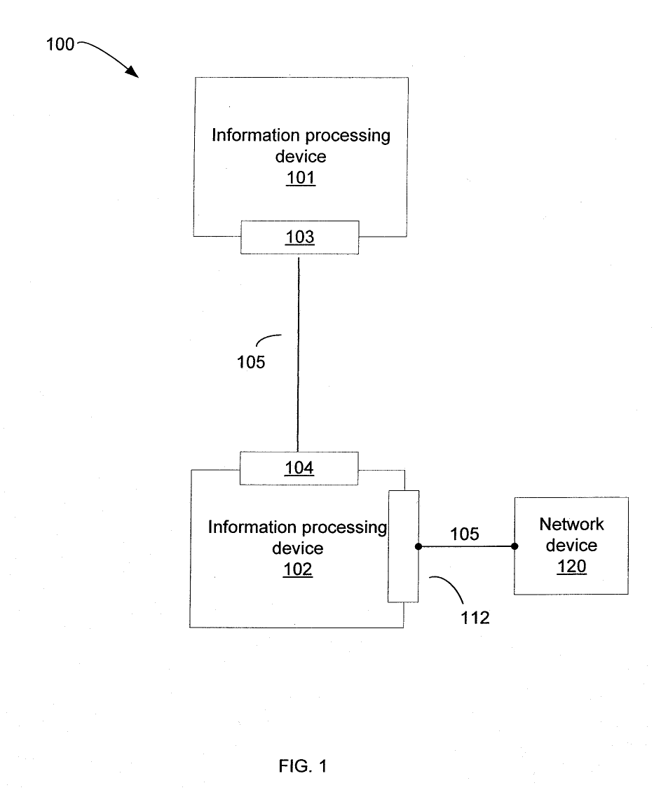

FIG. 1 illustrates a block diagram of a network system 100 in accordance with an example embodiment. The system 100 is shown to include an information processing device 101 with an I/O port 103 which may be used to communicatively couple the information processing device 101 to transmission medium 105. Similarly, the information processing device 102 includes I/O ports 104 and 112 which may be used to couple the information processing device 102 to the transmission medium 105. The network device 120 is coupled to the information processing device 102 via the I/O port 112 and/or other commercially available connection means. In an example embodiment, the information processing devices 101 and 102 are communicatively coupled together and coupled with the network device 120 when each are simultaneously coupled to transmission medium 105.

The information processing devices 101, 102 may be any electronic device that processes information according to a list of instructions. In an example embodiment, the information processing device 101 is a computer that includes a central processing unit (CPU) to manipulate information; the information processing devices 101, 102 may be a network device (e.g. a switch that operates on Ethernet layer 2 frames). The information processing devices 101, 102 may communicate with other devices (e.g., the network device 120) coupled to the transmission medium 105 using multiple communication protocols. For example, in example embodiments, the information processing devices 101, 102 may communicate over the transmission medium 105 using 10 gigabit Ethernet, internet SCSI (iSCSI), Fibre Channel, or any other protocols that can be communicated over Ethernet. In an example embodiment, the information processing devices 101 and 102 are network devices and are referred as network devices 101, 102 below.

The transmission medium 105 may be any medium suitable for carrying information between the network devices 101, 102. In an example embodiment, transmission medium 105 is a twisted pair cable to carry Ethernet communications. Other example embodiments may include combinations of transmission mediums that have various physical forms and collectively form an overall physical transmission medium (e.g. a combination of optical fiber, wireless, and twisted pairs coupled by routers, switches and/or other network devices, etc.).

The I/O ports 103, 104 may be interfaces (e.g., network adaptors) between a device (e.g. network devices 101, 102) and the transmission medium 105 that enable the device to receive and/or transmit information to and/or from the transmission medium 105. In an example embodiment, I/O ports 103, 104 are physical I/O ports that physically couple with the transmission medium 105 (e.g. via RJ-45 connector and cable) through a port (e.g. a port configured to receive an RJ-45 connector). In an example embodiment, I/O ports 103, 104 are configured to accommodate the use of multiple protocols communicated over transmission medium 105.

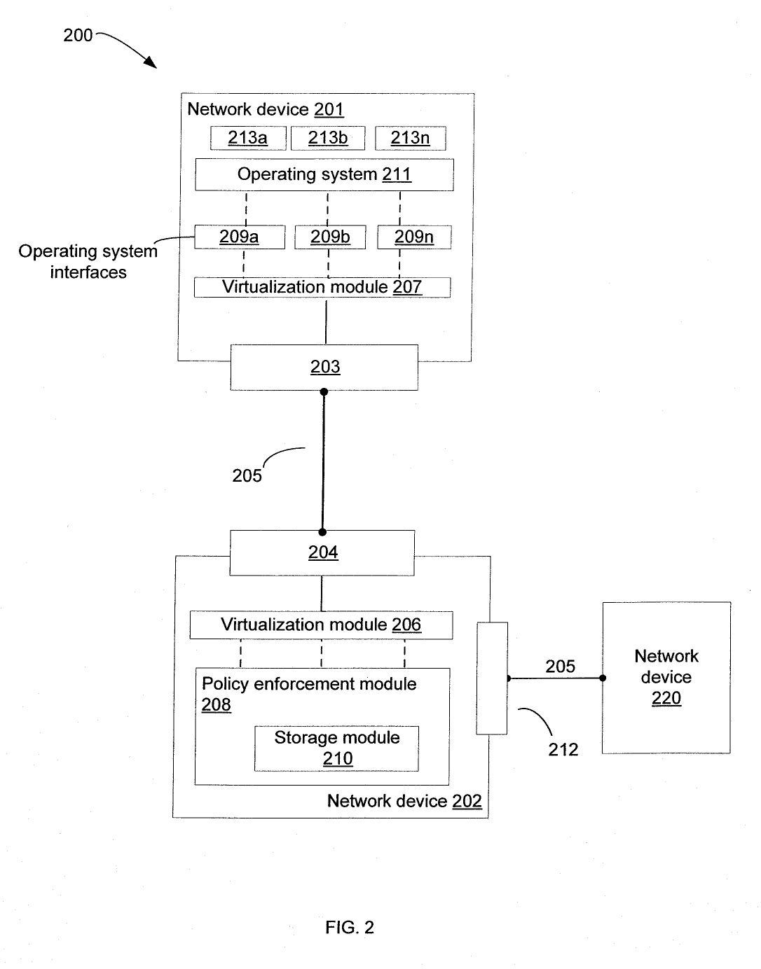

FIG. 2 illustrates a block diagram of a further example embodiment of a network system 200 in which network policy may be applied to communications originating at operating system interfaces.

FIG. 2 includes a network device 201 coupled with a network device 202 via I/O ports 203, 204 and a transmission medium 205. The I/O ports 203 and 204 may resemble the I/O ports 103, 104 described with respect to FIG. 1. The network device 220 is coupled to the network device 202 using I/O port 212 and/or any other commercially available connection means/arrangement. In an example embodiment, the characteristics of the network device 220 are substantially similar to the network devices 101 or 102.

The network device 201 includes a physical I/O port 203, a virtualization module 207, operating system interfaces 209a-n, one or more operating systems 211, and applications and/or services 213a-n.

A virtualization module 207 is communicatively coupled between the I/O port 203 and the operating system interfaces 209a-c. In an example embodiment, the virtualization module 207 receives information from, and sends information to, the operating system interfaces 209a-n. Further, the virtualization module 207 receives information from and sends information to the I/O port 203.

In an example embodiment, the virtualization module 207 receives separate frames from the operating system interfaces 209a-n; thus, the virtualization module 207 may receive n frames. In an example embodiment, the virtualization module 207 appends (e.g., tags) each of the n frames with an indicator to indicate the identity of the operating system interface (e.g. 209a, 209b or 209n) from which each separate frame originated. The virtualization module 207 then queues the appended frames for transmission over the transmission medium 205 (e.g., a single physical link) via the I/O port 203. Without the indicator, the identity of the source of the frames would be lost once they are transmitted over the single physical link. However, in an example embodiment, indicators appended to each frame that identify the source from which the frame originated may preserve the identity of the source. Accordingly, network policy management pertaining to that source may be managed at the remote network device 202. Thus, the virtualization module 207 in an example embodiment appends an indicator to each frame (or sequence of frames) so that, once transmitted, the indicator may indicate the operating system interface (e.g. 209a, 209b or 209n) from which the frames originated. It is to be understood that software and/or hardware other than the virtualization module 207 may append an I/O indicator in other example embodiments.

In an example embodiment, network devices (e.g., 202 and/or 220) that receive the appended frames (e.g., n sets of information) can determine the originating I/O port and use the indicator(s) to determine the identity of the operating system interface 209a-n from which the frames were received.

The virtualization module 207 may be logic implemented in hardware, software or a combination of hardware and software. In an example embodiment, the virtualization module 207 is a software layer (e.g. a software layer to virtualize hardware) in a hierarchical architecture that interfaces a computer's hardware with the computer's software. In another example embodiment, the virtualization module may be provided in hardware in a network adaptor or network interface card (NIC). Accordingly, the network interface card may define a virtual NIC that allows the source of the communications (e.g., frames) to be retained after virtualization of the frames.

The operating system interfaces 209a-n are communicatively coupled with the virtualization module 207 and the operating system(s) 211. In an example embodiment, the operating system interfaces 209a-n facilitate communication between the operating system 211 and the transmission medium 205. For example, the operating system 211 may require information located within a network device 220 that is coupled with the transmission medium 205. As such, the operating system 211 may request the information from an operating system interface 209a-n that will, in turn, send the request to the network device 220 via the virtualization module 207, the I/O port 203, the transmission medium 205, the I/O port 204, the network device 202 and the I/O port 212.

Each operating system interface 209a-n may send information to, and receive frames from, the virtualization module 207 using a communication protocol that is different from the communication arrangement that it uses to communicate with the operating system 211. In an example embodiment the operating system interfaces 209a-n may translate between a protocol language understood by the operating system 211 and a protocol language understood by the virtualization module 207. In an example embodiment, the operating system interfaces 209a and 209n may use an internet protocol (IP) and the operating system interface 209b may use fibre channel (FC) protocol to communicate with the virtualization module 207; neither of the above named protocols may be used to communicate with the operating system 211.

The operating system interfaces 209a-n may be logic implemented in software, hardware or a combination of the two. In an example embodiment, the operating system interfaces are software instructions processed by one or more processors associated with network device 201.

The operating system 211 may be software that manages hardware and software resources on network device 201. Operating system 211 may form a platform upon which applications and/or services 213a-n can run. In carrying out its functionality, the operating system 211 may send information to, and receive information from, the transmission medium 205 as described above. For example, on each one of a plurality of hardware devices (e.g., server machines), a plurality of different operating systems (e.g., Linux, Windows, etc.) may be deployed. Each operating system deployment may define a virtual server.

The applications and/or services 213a-n may be a software construction that is enabled by processor hardware (not shown) and the operating system 211, inter alia, to perform specific tasks defined by a user. In an example embodiment, the application software may be a spreadsheet application, word processing application, web server, transaction processing software, database, or any other application software, etc. Applications and/or services 213a-n may be the software that combines to form an operating system (e.g. operating system 211). In an example embodiment, the applications and/or services 213a-n may include software for controlling and allocating memory, prioritizing system requests, controlling I/O devices, facilitating networking, managing file systems, and other resources, etc.

Thus, the network device 201 may host one or more operating systems 211 and operating system interfaces 209a-n. Each of the operating system interfaces 209a-n may be interfaced with the one or more operating systems 211. The virtualization module 207 may receive a frame from one or more of the operating system interfaces 209a-n and append an indicator to the frame. In an example embodiment, the indicators may indicate to an information processing system (e.g. network device 202) an association between the frame and the one or more operating system interfaces (e.g., an indication of the operating system interfaces 209a-n from which the frame originated). The network device 201 may also include I/O port 203. In an example embodiment, the virtualization module may configure the frame (and e.g., with other frames associated with operating system interfaces (209a-n)) to be transmitted to another network device (e.g. 202) via a transmission medium 205.

The network system 200 in FIG. 2 is also shown to include the network device 202 (e.g. a network switch) having an I/O port 204, a virtualization module 206, and a policy enforcement module 208. In an example embodiment, it should be noted that the policy enforcement module 208 is remote from the virtualization module 207 and the transmission medium 205 (physical connection).

As stated above, the I/O port 204 may resemble the I/O ports 103, 104 in FIG. 1. In an example embodiment, the I/O port 204 receives information from the transmission medium 205 and forwards the information to the virtualization module 206.

In an example embodiment, the virtualization module 206 receives the appended frames and examines an indicator (e.g., of each frame) to identify the I/O port (e.g. I/O port 203) from which the frames were received (e.g., by reading a source address from a layer 2 header). It is to be understood that software and/or hardware other than the virtualization module 206 may examine the frames for an I/O indicator. In an example embodiment, the virtualization module 206 retrieves (e.g. parses) an indicator from each of the frames to identify the operating system interface (e.g. 209a, 209b or 209n) from which the particular frame originated.

In an example embodiment, the virtualization module 206 transmits each of the frames to the policy enforcement module 208. In addition, the virtualization module may transmit the identities of the originating I/O port and operating system interfaces (e.g. 203 and 209a-n) sending each particular frame.

The policy enforcement module 208 may be logic (implemented in hardware and/or software) to enforce defined network policy upon network nodes coupled to transmission medium 205. The network policy may be enforced to control a node's (or a plurality of nodes') ability to access other nodes, to define a node's scope of privileges, to prevent denial of service (DoS) attacks, to enforce firewall policies, and so on. An appropriate network policy may be selected based on the identification, or lack thereof, of a frame associated with a node or a user. Policy enforcement may include any mechanism to uphold a defined standard. It should be noted that the policies described above are included only for example and not as an exhaustive definition of network policy enforcement or to limit the disclosed patentable technology herein.

In an example embodiment the policy enforcement module 208 allows or denies transmission of the frame to other nodes (e.g., nodes or network devices coupled with the transmission medium 205) in accordance with the policy defined for the network, based at least in part on the identity of the I/O port and the operating system interface that originated the frame.

Thus, an I/O port (e.g. 204) of a network device (e.g. 202) may receive a frame from another network device (e.g. 201). A virtualization module (e.g., the virtualization module 206) may identify the operating system interfaces (e.g., one of 209a-n) from which the frame was received. Finally, a policy enforcement module (e.g., policy enforcement module 208) may enforce a network policy upon the frame based on an identity of the operating system interface (e.g., the identified operating system interface 209a-n). In an example embodiment the policy is enforced further based on an identified source I/O port (e.g., the I/O port 203).

In an example embodiment, the policy enforcement module 208 accesses a storage module 210 (e.g., utilizing a lookup table) to reference the policy to be applied to a frame originating at a particular operating system interface. A frame that violates policy may, for example, be dropped. In an example embodiment, the storage module 210 is located within the policy enforcement module 208 however, the storage 210 may reside in different locations in other embodiments.

In an example embodiment, the policy enforcement module 208 may determine that all, or some portion of, frames are permitted to reach (can be forwarded to) a desired destination network device coupled with the transmission medium 205. In an example embodiment, frames that originated at the operating system interface 209b may have a desired destination network device that is one of the operating system interfaces 209a-n. Thus, the destination operating system interface may be on the same network device 201. The policy enforcement module 208 may then transmit the frames to the virtualization module 206 where each of the frames are appended with at least one indicator to specify the appropriate destination I/O port and operating system interface. In the given illustrative example, the appropriate destination is I/O port 203 and operating system interface 209a.

In an example embodiment, I/O port 204 transmits the frames with their associated indicators to I/O port 203 across the transmission medium 205. In an example embodiment, the virtualization module 207 may retrieve (e.g., parse) an indicator from each frame to identify one or more operating system interfaces 209a-n that are to receive the particular frame. Continuing with the example of the frame from operating system interface 209b, as described above, the virtualization module 207 may forward particular frames to the operating system interface 209a. The information within the frames may then be translated by the operating system interface 209a and forwarded to the operating system 211.

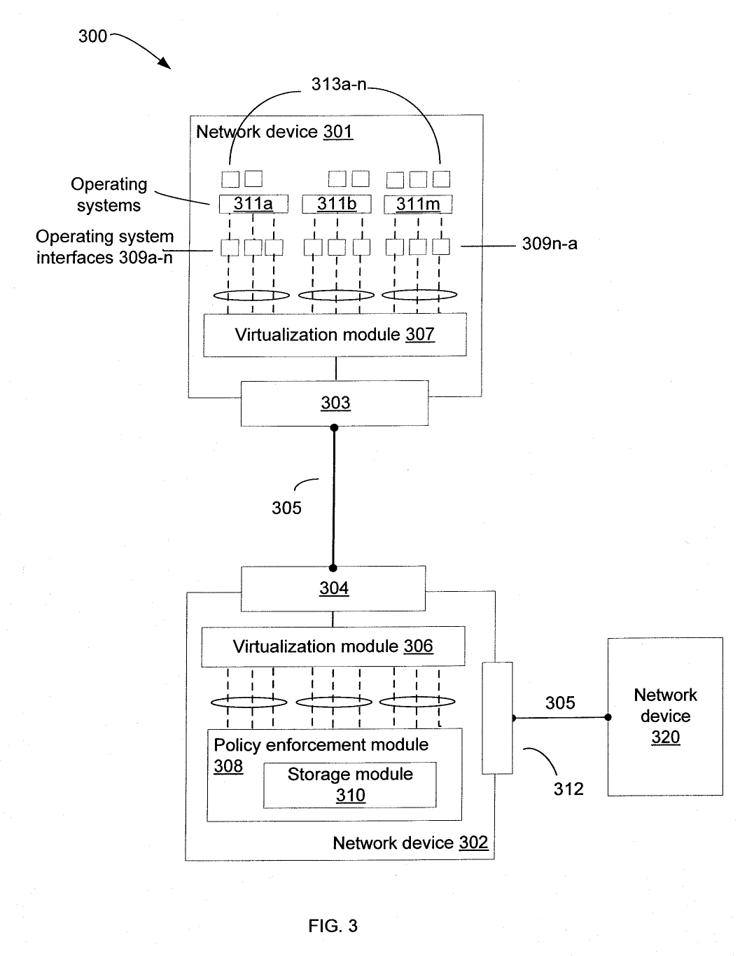

FIG. 3 illustrates a block diagram of a network system 300 in accordance with a further example embodiment. The system 300 includes a network device 301 coupled to the network devices 302, 320 via I/O ports 303, 304, 312 and a transmission medium 305 (physical connection). The network device 301 includes the physical I/O port 303, a virtualization module 307, operating system interfaces 309a-n, operating systems 311a-m and applications and/or services 313a-n. In an example embodiment, the operating systems 311a-311m exist on virtual machines that are instantiated on the network device 301.

Although the network device 301 includes additional components, each of the above described components may be similar to the corresponding components described with respect to FIG. 2. For example, the applications and/or services 313a-n, the operating systems 311a-m and the operating system interfaces 309a-n may be substantially similar to the applications and/or services 213a-n, the operating system 211 and the operating system interfaces 209a-n of FIG. 2.

As shown, each operating system 311a-m may support multiple applications and/or services 313a-n. Additionally, each operating system 311a-m may communicate through multiple operating system interfaces 309a-n. In an example embodiment, the number of applications and/or services 313a-n is different for different operating systems 311a-m and the number operating system interfaces need not be uniform across the operating systems 311a-m or the applications and/or services 313a-n.

In an example embodiment, the operating system 311a may signal or command the operating system interface 309a to communicate a frame over transmission medium 305 using iSCSI protocol. At the same time, the operating system 311a may signal the operating system interface 309b to communicate over transmission medium 305 using FC protocol. The operating systems 311b-m may also signal or command the operating system interfaces 309d-n to communicate with the transmission medium 305 with various similar and/or dissimilar communication protocols that are supported by the operating system 311a-m making the request. The operating system interfaces 309a-n may receive the request and forward it to the virtualization module 307.

The virtualization module 307 may receive frames from the operating system interfaces 309a-n as described above by way of example with respect to operating system interfaces 209a-n in FIG. 2. However, in this embodiment, the operating system interfaces 309a-n may communicate with the virtualization module 307 on behalf of the different operating systems 311a-m. In an example embodiment, the virtualization module 307 may append (or include in any manner) an indicator to each frame to indicate the identity of the operating system interface from which each frame originated.

In an example embodiment, the virtualization module 307 may arrange the appended frames into a queue from which they are transmitted to the I/O port 303 and then to transmission medium 305. The virtualization module 307 may additionally append an indicator to the frames to indicate the I/O port (e.g., the I/O port 303) from which the frames originated. It is to be understood that software and/or hardware other than the virtualization module 307 may append (or include) an I/O port indicator in other example embodiments.

The network device 302, the virtualization module 306 and the I/O port 304 may be substantially similar to their counterparts in FIG. 2. In an example embodiment, the virtualization module 306 receives frames appended with appropriate indicators and examines each indicator to identify the I/O port (e.g., I/O port 303) from which the frame was received (e.g., by reading a source address from a layer 2 header). It is to be understood that, in other example embodiments, software and/or hardware other than the virtualization module 306 may examine the frame for an I/O indicator. In an example embodiment, the virtualization module 306 retrieves (e.g. parses) an indicator from each of the frames to identify the operating system interface (e.g. 309a-n) from which the frame originated.

In an example embodiment, the virtualization module 306 may transmit each of the frames to a policy enforcement module 308. In addition, the virtualization module 306 may transmit the identities of the originating I/O port and operating system interfaces (e.g., 303 and 309a-n).

In an example embodiment the policy enforcement module 308 allows or inhibits communication of the frame to other nodes in accordance with, or based on, the policy defined for the network. The policy may be stored within storage module 310. The policy may be based, at least in part, on the identity of the I/O port and the operating system interface from which the frame originated. Thus, the example embodiments disclosed above may allow effective and economical enforcement of network policy upon virtual network interfaces.

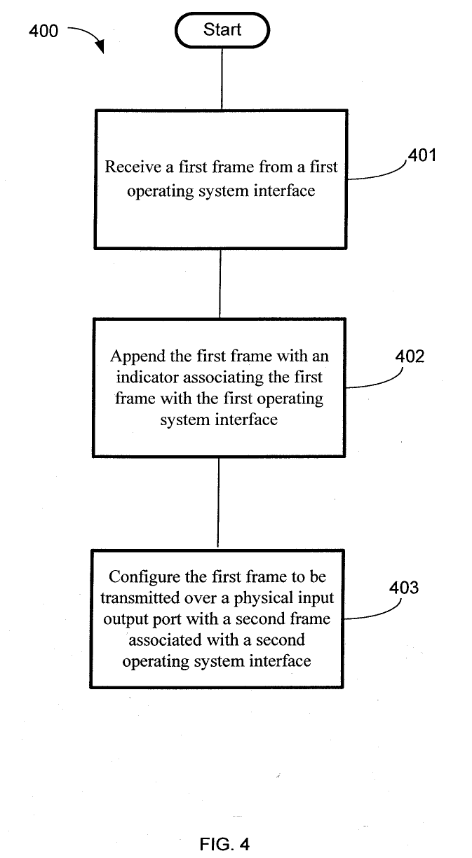

FIG. 4 is a flow diagram of a method 400, in accordance with an example embodiment, for enabling the application of network policy enforcement to operating system interfaces. In FIG. 4, the method 400 processing logic receives frames from one or more operating systems via operating system interfaces.

In an example embodiment, an operating system located on a computer (e.g., a server) sends information to the processing logic through the computer's operating system interfaces (e.g. protocol engines located on a computer). The process may begin at block 401 with processing logic receiving a first frame from a first operating system interface. Thereafter, as shown at block 402, the processing logic appends an indicator to each frame to associating the frame with a source operating system interface (see block 402).

As shown at block 403, the method 400 may then configure the frame and other frames that are associated with various operating system interfaces to be transmitted over a common I/O port.

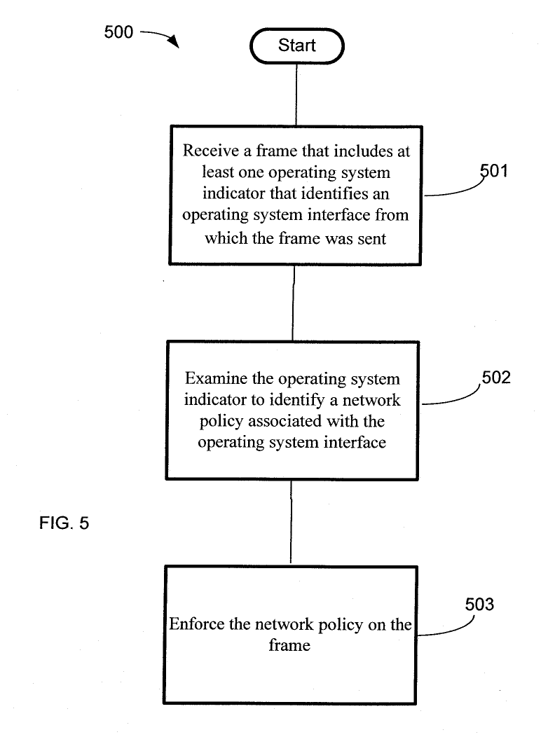

FIG. 5 is a flow diagram of a method 500, in accordance with an example embodiment, for enabling the application of policy enforcement to operating system interfaces. In an example embodiment, method 500 is performed by components of the information processing device 102, 202 and 302 (e.g., network devices) shown in FIGS. 1, 2, and 3.

The method 500 begins with processing logic receiving a frame (see block 501) (e.g., from an operating system(s) through operating system interfaces and an I/O port) that includes at least one operating system interface indicator (e.g., a tag) that identifies an operating system interface from which the frame was sent. Thereafter, as shown at block 502, the operating system indicator is examined to identify a network policy associated with the operating system interface. As shown in block 503 the method may conclude with the appropriate network policy being enforced on the frame.

Through the methodology disclosed above, effective and economical enforcement of network policy upon virtual network interfaces may be realized. Utilizing the example embodiments, network administrators applying a new network policy to a network need not install hardware and software on each terminating network node; rather, a fewer number of intermediate network nodes are enabled to enforce policy upon operating system interfaces (e.g. virtual interfaces). In an example embodiment, network administrators may update fewer nodes (e.g., only the intermediate nodes and not the network adaptors themselves) to apply a new policy across a network.

As mentioned above, the example embodiments may be implemented in software, hardware or a combination thereof. For example, in some example embodiments, the methods described herein may be implemented by computer program product or software which may include a machine or computer-readable medium having stored thereon instructions which may be used to program a computer (or other electronic devices). In other example embodiments, the functionality/methods described herein may be performed by specific hardware components (e.g., integrated circuits) that contain hardwired logic for performing the functionality, or by any combination of programmed computer components and custom hardware components.

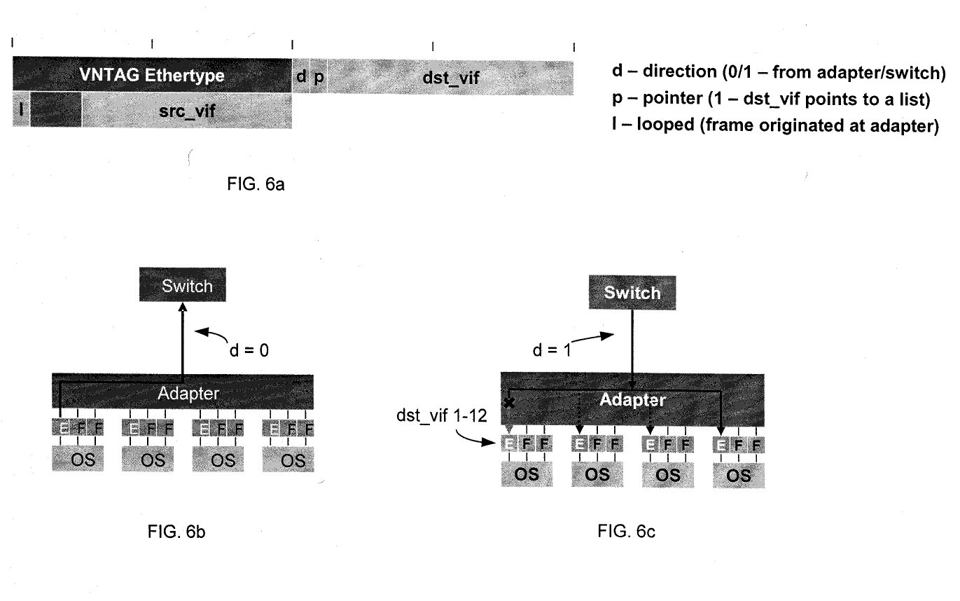

FIG. 6a illustrates example fields within a frame. The fields shown in FIG. 6a may be used to identify I/O ports, operating system interfaces (e.g., virtual interfaces) and provide additional information (examples discussed below) to enable policy enforcement upon operating system interfaces.

A frame may be a set of information of fixed or variable length that is encoded by a communications protocol for digital transmission over a node-to-node link. In an example embodiment, a frame may be encoded with data link layer protocol (Layer 2). Example embodiments described herein are not limited to the use of a frame to identify the origin of information; rather, frames are used by way of example and not limitation.

FIGS. 6b and 6c are block diagrams illustrating example embodiment of network systems. In the example embodiments, frames may be communicated between an adapter and a switch. The example embodiments of frame fields shown in FIG. 6a may be used to transfer information that can be used to practice example embodiments disclosed herein. Information within the frame fields may enable network policy enforcement upon virtual interfaces performed by a policy enforcement switch located within the network itself. Further, information within the example frame fields can be used to enable frame delivery from a policy enforcement switch, to virtual interfaces.

In FIG. 6a, a field “d” may be used to indicate frame direction. In the example embodiment shown in FIGS. 6a-6c, if d=0 then the frame is being transmitted from an adapter (e.g. a network terminal) to a switch (e.g. including a policy enforcement module as herein before described). For example as shown in FIG. 6b, where the frame is shown to include a value of d is set to “0”. However, when the frame is transmitted towards the adapter, d is set to “1” to indicate that the frame is being transmitted from a policy enforcement module to an adapter (see FIG. 6c).

In an example embodiment, a further identifier field “p” is provided. The “p” field may indicate how the information in the destination interface field should be used. For example, if p=0 then the information in the destination virtual interface field (“dst_vif”) may represent the address of the virtual interface to which a frame is to be delivered (e.g. a operating system interface). However, if p=1 then the information in the “dst_vif” field may be a pointer to an entry in a list. The entry in the list may contain a list of virtual interfaces to which the frame is to be delivered. FIG. 6c illustrates an example embodiment of frames being delivered to virtual interfaces at specific dst_vif locations. In this example embodiment, frames are delivered to dst_vif locations 1, 4, 7 and 10 (as indicated by arrows descending from the adapter).

The “1” field in FIG. 6a may indicate whether a frame's destination port is the same as its source port. If ‘1’=1, then the frame has been looped; if ‘1’=0 then the frame has not been looped. In an example embodiment, a looped frame may be received by its originating port but it may not be received by its originating virtual interface. Accordingly, when ‘1’==1, and src_vif==dst_vif, a network policy prevents the frame from being delivered to the dst_vif location (e.g., when the source and the destination operating system interfaces are the same). In an example embodiment, illustrated in FIG. 6c, x indicates that a frame directed towards dst_vif 1 is dropped under the above described conditions).

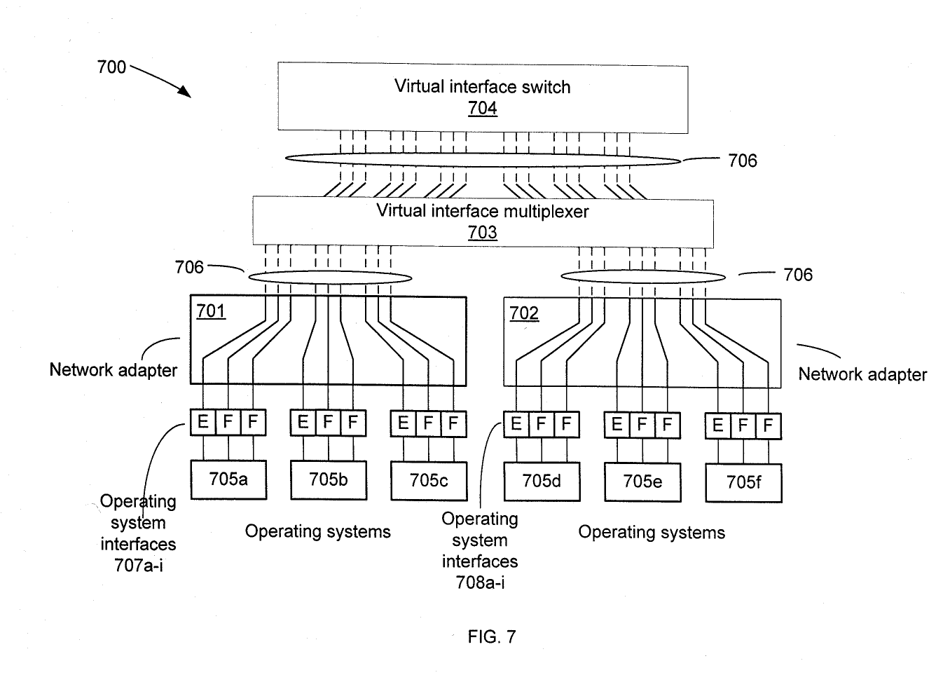

FIG. 7 is a block diagram of a network system 700, in accordance with an example embodiment. The system 700 is shown to include operating systems 705a-f which may be any operating system (e.g. Linux, Microsoft Windows XP, UNIX or any other available operating system that communicates with a network, etc.). Operating system interfaces 707a-i and 708a-i may be software or hardware (or a combination thereof) that implement layers of a protocol stack (e.g. logic to transform operating system commands to network protocols). The system 700 is also shown to include network adapters 701, 702 that virtualize and tag frames sent from the operating systems 705a-c and to operating systems 705d-f through operating system interfaces 707a-i, 708a-i.

In an example embodiment, virtualization includes transmitting frames from different virtual interfaces (e.g., operating system interfaces) so that the frames can be transmitted through a single Ethernet cable 706 to a virtual interface switch 704. Virtualization of frames may also include parsing the frames so that the frames can be distributed to a particular destination based on a defined policy.

In an example embodiment, tagging frames includes appending an indicator to a frame to indicate the frame's source or destination operating system interface (e.g. 707a-i, 708a-i) and I/O port (not shown).

In an example embodiment, the adapters 701, 702 each send and receive frames (frames from/to each of 707a-i, 708a-i) over a single twisted pair Ethernet cable 706. In an example embodiment, the virtual interface multiplexer 703 sends and receives frames over a single twisted pair Ethernet cable connected with adapters 710, 702. The virtual interface multiplexer 703 may be a multiplexer configured to receive and forward frames, inter alia, from the virtualization interfaces (e.g. 707a-i, 708a-i) that have been virtualized by adapters 701, 702 for transfer over a single cable (e.g. 706). In addition, the virtual interface multiplexer 703 may be configured to receive and forward frames, inter alia, from virtual interface switch 704.

The virtual interface multiplexer 703 may include logic designed to perform the above disclosed functions. The virtual interface multiplexer 703 may be realized through hardware or software configuration or a configuration that includes both hardware and software.

In an example embodiment, a virtual interface switch 704 is a network device that enforces network policy upon frames originating at virtual interface adapters. In an example embodiment, the virtual interface switch 704 receives frames from all 18 operating system interfaces 707a-i and 708a-i. Because each frame is tagged with one or more identification indicator, the virtual interface switch 704 can apply network policy to each of the operating system interfaces 707a-i, 708a-i. Those frames that violate policy are dropped (e.g. denied access to a destination node). Those frames that do not violate policy may be forwarded to a desired destination. Those frames whose desired destination is one or more of operating system interface 707a-i, 708a-i are tagged for that destination and virtualized to enable transmission over a single Ethernet cable to the virtual interface multiplexer 703.

After being de-multiplexed, frames are received by the virtual adapters 701, 702. Each of the adapters 701, 702 may then read each frame's tags to determine which of the virtual interfaces 707a-i, 708a-i is each of their destination(s).

Example embodiments described above may enable network policy to be efficiently and economically enforced on networks including nodes who communicate from virtual interfaces through single physical wires. By enforcing policy on intermediate devices within the network instead of on every termination node, the time and cost associated with implementing network policy can be reduced.

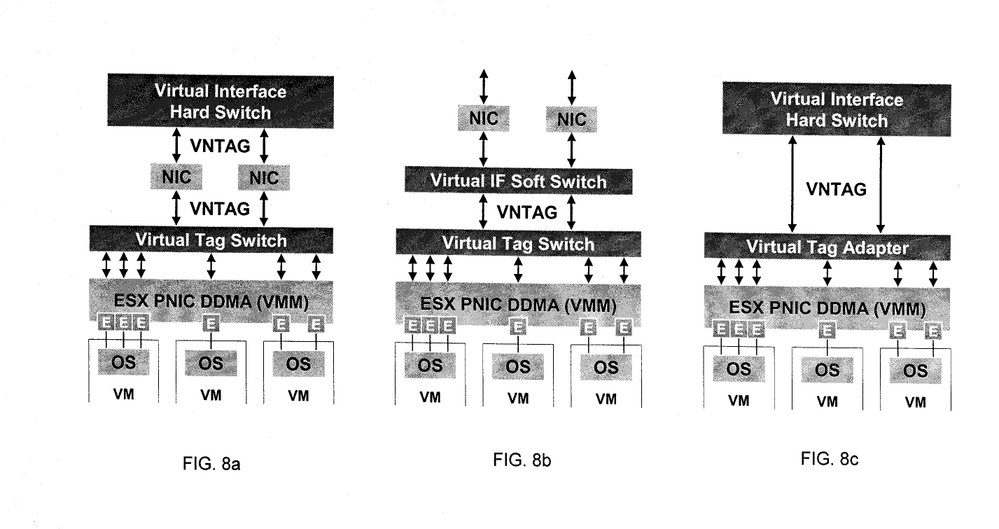

FIGS. 8a, 8b and 8c are block diagrams illustrating example communication networks in which embodiments may be applied. In FIG. 8, what is taught through the embodiments described above may be implemented with existing virtualization software. In an embodiment, the direct DMA “hypervisor” interfaces are leveraged through inserting “src_vif” on egress frames and distributing ingress frames based on “dst_vif.” Embodiments in FIG. 8 may support local and remote virtual interface switches. Local switches may be supported with “softswitch” and remote switches with “hardswitch.”

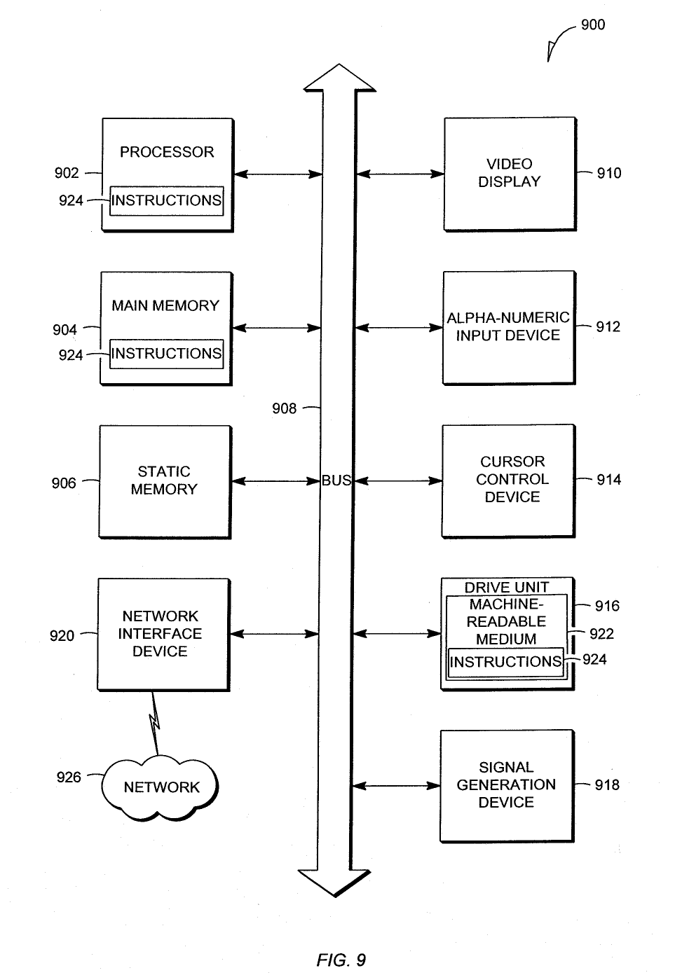

FIG. 9 shows a diagrammatic representation of a machine in the example form of a computer system 900 within which a set of instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920 utilizing any one of a number of well-known transfer protocols (e.g., FTP).

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an example embodiment of the present invention has been described with reference to specific example embodiments, it will be evident that various modifications and changes may be made to these example embodiments without departing from the broader spirit and scope of the invention. Accordingly, the specification and drawings are to be regarded in an illustrative rather than a restrictive sense.

Thus, a method and apparatus for applying network policy to communications originating at operating system virtual interfaces has been described. It is to be understood that the above description is intended to be illustrative and not restrictive. Many other example embodiments will be apparent to those of skill in the art upon reading and understanding the above description. The scope of the invention should, therefore, be determined with reference to the appended claims, along with the full scope of equivalents to which such claims are entitled.

What is claimed is:

1. A network system comprising:
a network device being communicatively coupled with a switch, the network device including,
a first operating system interface,
a first virtualization adapter, and
an input output port,
the first virtualization adapter being configured to receive a first frame from the first operating system interface and to tag the first frame to indicate an association between the first frame and the first operating system interface, and to configure the first frame to be transmitted, with a second frame associated with a second operating system interface, via the input output port, and
the switch being configured to receive the first frame and examine a tag, and to enforce a network policy upon the first frame, based on the tag.

2. The system of claim 1, wherein the network device further comprises:
a first operating system being configured to generate first data, wherein the first operating system interface is configured to receive the first data and to translate the first data into the first frame.

3. The system of claim 1, wherein the switch includes a second virtualization adapter to append a further tag to the first frame to indicate one or more operating system interfaces permitted to receive the first frame under the network policy, and wherein the first virtualization adapter is to,
receive the frame from the switch,
inspect the further tag, and
based on the further tag, direct the first frame to the one or more operating system interfaces.

4. The system of claim 2, wherein the network device includes a plurality of virtual machines, each being configured to communicate frames with the switch via separate operating system interfaces, the virtualization adapter and the input output port.

5. A method comprising:
receiving a frame including a first operating system indicator identifying an operating system interface from which the frame was sent;
examining the first operating system indicator to identify a network policy associated with the operating system interface; and
enforcing the network policy on the frame.

6. The method of claim 5, wherein the operating system interface is a virtual interface corresponding to an operating system virtualized on a computer.

7. The method of claim 6, wherein the operating system is associated with a plurality of operating system interfaces.

8. The method of claim 5, further comprising:
accessing a storage module including a plurality of operating system indicators and a plurality of network policies, each of the plurality of operating system indicators being associated with at least one network policy; and
identifying the at least one network policy corresponding to the first operating system indicator.

9. The method of claim 5, further comprising:
accessing a header within the frame identifying a source input/output port from which the frame was received; and
enforcing the network policy based on an identity of the source/input output port.

10. The method of claim 5, wherein the enforcing of the network policy includes at least one of enforcing access rights of a network device communicating with the network node, regulating a scope of privileges of a network device communicating with the network node, preventing a denial of service attack of the network node or enforcing a firewall policy at the network node.

11. The method of claim 8, wherein the enforcing of the network policy includes allowing or denying transmission of the frame to a destination input output port based on the network policy.

12. The method of claim 8, wherein the frame includes a direction indicating whether the frame is inbound to the node or outbound from the node, and wherein the identifying of the at least one network policy includes referencing a table entry containing a list of operating system interfaces permitted to receive the frame.

13. An apparatus comprising:
a first network device to receive a frame from a second network device;
a virtualization module to identify an operating system interface from which the frame was received; and
a policy enforcement module to enforce a network policy upon the frame based on an identity of the operating system interface.

14. The apparatus of claim 13 wherein the virtualization module is further to access a header within the frame to identify a source input output port from which the frame was received, and the policy enforcement module is to enforce the network policy further based on an identity of the source input output port.

15. The apparatus of claim 13, wherein the policy enforcement module is to access a storage module to reference the network policy.

16. The apparatus of claim 15, wherein the policy enforcement module is configured to enforce at least one of access rights, a scope of privileges, a denial of service attack prevention policy or a firewall policy.

17. The apparatus of claim 14, further comprising:
an input output port to transmit the frame to a destination network address if the network policy permits.

18. A method comprising:
receiving a first frame from a first operating system interface;
appending the first frame with an indicator associating the first frame with the first operating system interface; and
configuring the first frame to be transmitted over a physical input output port with a second frame associated with a second operating system interface.

19. The method of claim 18 wherein the associating of the first frame with the first operating system interface includes indicating that the first frame was received from the first operating system interface.

20. The method of claim 18, further comprising:
receiving data expressed in a first communication protocol from an operating system; and
translating the data into the first frame expressed in a second communication protocol.

21. An apparatus comprising:
a first operating system interface; and
a virtualization module to,
receive a first frame from the first operating system interface,
append an indicator to the first frame to indicate an association between the first frame and the first operating system interface, and
configure the first frame to be transmitted over an input output port, with a second frame associated with a second operating system interface.

22. The apparatus of claim 21, wherein the virtualization module is to append the indicator to indicate that the first frame was received from the first operating system interface.

23. The apparatus of claim 22, wherein the first operating system interface is configured to receive data expressed in a first communication protocol from an operating system, and is to translate the data into the first frame expressed in a second communication protocol.

24. A machine-readable medium containing instructions which, when executed by a processing system, cause the processing system to perform a method, the method comprising:
receiving a frame including at least one operating system indicator identifying an operating system interface from which the frame was sent;
examining the operating system indicator to identify a network policy associated with the operating system interface; and
enforcing the network policy on the frame at the network device.

25. A network system comprising:
means for receiving a first frame from a first operating system interface;
means for appending the first frame with an operating system indicator associating the first frame with the first operating system interface;
means for configuring the first frame to be transmitted over a physical input output port with a second frame associated with a second operating system interface;
means for receiving the first frame from the first input output port;
means for examining the operating system indicator to identify a network policy associated with the first operating system interface; and
means for enforcing the network policy on the first frame.
